(19) United States
(12) Patent Application Publication
(10) Pub. No.: US 2007/0142585 A1
(43) Pub. Date: Jun. 21, 2007

(54) Devolatilization of anhydride multi-polymers

(76) Inventor: Eugene R. Moore, Midland, MI (US)

Correspondence Address: BERND W. SANDT, 900 DEERFIELD COURT, MIDLAND, MI, 48640, US

(21) Appl. No.: 11/634,281

(22) Filed: Dec. 5, 2006

Related U.S. Application Data
(60) Provisional application No. 60/751,087, filed on Dec. 19, 2005.

(51) Int. Cl. C08F 224/00

(52) U.S. Cl. 526/266; 526/346

(57) ABSTRACT

The present invention relates to the formation of low volatile anhydride-containing vinyl polymers by polymerizing the half ester of the anhydride with a vinyl aromatic monomer followed by devolatilizing the half-ester multi-polymer at elevated temperature and reduced pressures.

The present application is a continuation in part of provisional application Ser. No. 60/751,087 filed Dec. 19, 2005.

### FIELD OF THE INVENTION

The present invention relates to the devolatilization of melts of one or more polymers. More particularly the present invention relates to improved devolatilization of multi-polymers of styrene with or without acrylonitrile and maleic anhydride, wherein a chemical derivative of maleic anhydride is produced prior to entering the high temperature, zone of a vacuum devolatilization system. Volatile monomers and solvents are quickly removed while the derivative decomposes more slowly releasing a stripping agent “in situ”. This two-stage action in a single devolatilization system accomplishes residual monomer lowering which would normally require two complete devolatilization systems.

### BACKGROUND OF THE INVENTION

In the preparation of styrene copolymers or terpolymers with maleic anhydride or similar unsaturated anhydrides, by mass and solution polymerization, devolatilization of unreacted monomer, solvent and other volatile components is an absolutely vital step. As polymer technology has progressed, the acceptable level of residual volatile material, particularly as monomer, in a polymer has decreased. While low residual monomer is important for all commercial applications, it is of particular importance in food contact applications where taste and odor contributions to the food are found at relatively low levels. Various means have been employed in the past to reduce volatile content in commercial polymers.

Multi-polymers, i.e., polymers involving more than one monomer, such as polymers of styrene and maleic anhydride are of particular interest for food contact applications. This interest comes from the increase in heat resistance that results from copolymerization with maleic anhydride. For each added percent of maleic anhydride the heat distortion temperature of the copolymer is increased by nearly 2° C. (Ind. Eng. Chem. Prod. Res. Dev. 1986, 25, 315-321).

Two of the most sought after properties for styrene-based polymers are heat resistance and lower residual monomer contact This invention addresses both of these needs in a unique and simple way. At the same time some embodiments of this invention greatly simplify the polymerization problems associated with producing homogenous multi-polymers with maleic anhydride. Past art has generally addressed each of these separately.

Street in U.S. Pat. No. 3,536,787 noted that rubber modified, high impact polystyrene containing 3-5% unreacted styrene could be devolatilized to 2000 ppm of styrene monomer in an extruder devolatilizer system. Street then demonstrated that injection of 0.1% water as a stripping agent, prior to the extruder lowered the styrene content to 1000 ppm. Generally polymerization to 95-97% conversion level disclosed by Street is not practical because of the long polymerization time required. Further, an extruder devolatilization system is not considered practical for large-scale commercial operations. High capital and operating cost as well as operational problems with vacuum line plugging are among major deterrents to their use.

Fujimoto, in U.S. Pat. No. 3,987,235, discloses a devolatilization by introducing methanol into molten styrene polymer and removing the volatiles under vacuum.

Skilbeck has shown in U.S. Pat. No. 5,380,822 (which is hereby incorporated by reference) that a previously devolatilized molten blend of polystyrene and rubber modified polystyrene containing less than 2 weight % residual monomer could be further reduced by dispersing water as a stripping agent into the molten stream and passing it through a vacuum devolatilization system.

Maleic anhydride, MA, can be used as a comonomer to increase heat resistance of polystyrene, but requires intensive mixing during copolymerization. Moore (Ind. Eng. Chem. Prod. Res. Dev. 1986, 25, 315-321) teaches conditions to produce homogeneous copolymers of styrene and 0 to 33% of MA. Moore later demonsrated (U.S. Pat. No. 3,919,354) that high impact copolymers of styrene and MA could be produced in a series of reactors. These copolymers all have Vicat softening points that are about 2° C. above that of homopolymer polystyrene for each added percent of MA.

It is desirable to produce temperature resistant copolymers of styrene and similar vinyl aromatic monomers and maleic anhydride or similar unsaturated anhydrides with a reduced need for mixing. It is also desirable to produce polymers with reduced levels of residual styrene without the need for a second devolatilization system.

High degrees of agitation are necessary m order to produce homogeneous copolymers of styrene and MA. If agitation is gradually reduced the first indication of a lack in homogeneity will be a slight haze Further reduction will produce a cloudy copolymer and a still further reduction will result in an opaque copolymer. In a crystal grade copolymer clarity is of value for most applications. A haze will thus reduce the value of copolymer for most unpigmented applications. Cloudiness will reduce value further and there are relatively few commercial applications that will accept an opaque polymer. Rubber modified styrene/maleic anhydride copolymers are more tolerant of non-homogeneous polymer but will see a loss in impact strength when there is a high degree of non-homogeneity. It is desirable to produce a heat resistant styrene copolymer or terpolymer or rubber modified heat resistant polymer with reduced agitation requirements.

The present invention is based on the discovery that it is possible to reduce agitation requirements of the prior art in the polymerization of styrene and MA by using half esters of maleic anhydride with lower molecular weight alcohols and at the same time obtain improved devolatilization of residual styrene with the reformation of MA in the polymer.

### SUMMARY OF THE INVENTION

The present invention relates to the preparation of multi-polymers of an ethylenically unsaturated dicarboxylic acid anhydride, having from 4 to 8 carbon atoms, preferably maleic anhydride (MA), with an alkenyl aromatic monomer of 8 to 12 carbon atoms, most commonly styrene, of low residual volatiles, comprising reacting the anhydride with a volatile alcohol having from 1 to 4 carbon atoms to form the half ester of the anhydride, polymerizing the half ester with the aromatic vinyl monomer and devolatilizing the resulting polymer at reduced pressure and elevated temperatures at which the anhydride is reformed and the alcohol released.

Stated alternatively the process of the present invention provides a process for the reduction of residual monomer in multi-polymers of MA with a vinyl aromatic monomer, such as styrene by polymerization with a half ester of MA. This and other advantages are gained with the use of an in situ generated stripping agent This “in situ” stripping agent is generated by release of a short chain alcohol when the half ester of maleic anhydride is converted back to the original anhydride.

The maleic half esters are easily produced at moderate temperatures (on the order of 60° C.) where equilibrium favors the half ester by direct reaction of the MA with a volatile alcohol. At elevated temperatures, however, the anhydride form of maleic becomes increasingly favored in an equilibrium reaction if enough pressure is maintained to prevent the escape of alcohol, the half-ester form appears to predominate. If the pressure is, however, lowered so as to allow the alcohol to escape the reaction steadily reverses until only the anhydride form remains. As the ester reverses the alcohol is released Apparently the kinetics of the reverse reaction are slow relative to the rapid speed for the vaporization process that removes the styrene monomer and solvent. This difference in speed allows the alcohol to remain bound as the half ester until most of the styrene monomer has vaporized.

This slow release of alcohol during the devolatization step has the surprising but very desirable result of providing the same type of residual lowering stripping action in one devolat lization system that is provided by two systems in the practice of the prior art.

Since the half esters of interest arc liquid at ambient temperatures, problems associated with handling molten MA above its melting point are also eliminated. There is the need to maintain all storage, pumping, and piping systems above the 54-56 degree C. melting point of MA. The high vapor pressure also causes a foul odor, which requires an exhaust system that frequently becomes plugged with condensed MA crystals.

### DETAILED DESCRIPTION OF THE INVENTION

The formation of random, homogeneous multi-polymers of aromatic vinyl monomers of 8 to 12 carbons, such as styrene, with MA and similar anhydrides is well known in the art (See U.S. Pat. No. 2,971,939, Ind. Eng. Chem. Prod. Res. Div., 1986, 25, 315-321, which am hereby incorporated by reference). Similarly the formation of rubber modified random polymers of styrene and MA is well known in the art (See U.S. Pat. No. 3,919,154, which is hereby incorporated by reference). The MA content in such polymers generally varies from 0.3 to 33% by weight and preferably from 2 to 25% by weigh of the aromatic vinyl monomer and the MA. In the present invention the same polymerization conditions can similarly be employed for the half esters of the dicarboxylic acid anhydride. It is not essential that all of the anhydride be converted to the half ester. At the lower concentrations of the anhydride a higher conversion of the anhydride to the half ester is usually desired to provide the desired devolatilization. Generally speaking it is usually desired that the half ester be present in at least 50% of the anhydride composition and hence in a concentration of at least 1 weight % up to 25 weight %. However it is possible to convert up to 90% of the anhydride to the half ester. It is furthermore not necessary that the half ester be separately formed, even, though such is preferred, and then added to the materials to be polymerized since it is possible to add the alcohol to the monomer composition before polymerization to form the half ester in

### EXAMPLES

### Comparative Example 1

The production of a 5%, by weight of the polymer, maleic anhydride (MA) copolymer with styrene is carried out as described by Moore (Ind. Eng. Chem. Prod. Res. Dev. 1986, 25, 315-321) using the described recirculating reactor at a temperature 126° C. As illustrated by Moore the stream exiting from the polymerization reactor is fed to a heat exchanger where the polymer is brought up to devolatilization temperatures and then through a vacuum chamber where devolatilization takes place. The feed stream is molten MA and styrene and initially the copolymer being formed is clear. As the run progresses the recirculation pump rate is decreased in stages until a distinct haze is visible in the cooled product. Analysis of the polymer shows a residual styrene content in excess of 600 ppm for the whole series of runs.

### Example 2

The run of example 1 is repeated while still at the reduced recirculation rate and the MA feed stream is replaced with a liquid stream of the methyl half ester of MA. This ester is formed by placing a stoichiometric amount (one mol MA per mol of methanol) of MA and methanol in a heated chamber (above the melting point of MA) until conversion to the ester exceeds 90% and then adding it to the feed stream into the polymerization reactor. When the polymerization reactor reaches steady state operation, the copolymer of the half ester of MA and styrene (containing about 5% of the half ester) no longer has a detectable haze. Subsequently the recirculation rate is slowed in several more stages before a haze again develops. Analysis of the polymer following devolatilization shows a residual styrene content below 400 ppm Approximately 1.6-wt % methanol is calculated to be released in the devolatilizer.

### Example 3

Example 2 is repeated except while a stoichiometric amount of methanol is added conversion to the half ester is only 50%. Somewhat higher agitation rates than in example 2 are required to remove the haze. Residual styrene content was again below 400 ppm.

### Example 4

Example 2 is repeated except molten MA and the stoichiometric amount of methanol are add separately to the polymerization feed stream. Only a slight reduction in recirculation rate is possible before the haze appears. The residual styrene content, however, is again below 400 ppm. It appears that the half ester is formed during the polymerization reaction. This example demonstrates that as long as the half ester is present immediately before the devolatilization step the desired reduction in volatile content is obtained

### Example 5

Example 2 is repeated except a stoichiometric amount of ethanol is substituted for methanol. Similar beneficial results are obtained.

These examples illustrate several of the advantages of this invention. Most important of these advantages is the surprising reduction in residual monomer. Also it is seen that the equipment required to handle MA is greatly simplified by the use of the half ester since the half ester is liquid at ambient conditions while MA is solid. It is further seen that less agitation is required when polymerizing the half ester than with MA. This is important because many commercial reactors are not capable of the high degrees of agitation used by Moore (Ind. Eng. Chem. Prod. Res. Dev. 1986, 25, 315-321).

### Comparative Example 6

Example 1 is repeated except conditions are adjusted as described by Moore (Ind. Eng. Chem. Prod. Res. Dev. 1986, 25, 315-321) to produce a 25% MA copolymer at a temperature of 80° C. The feed stream is molten MA and initially the copolymer is clear. As the run progresses the recirculation pump rate is again decreased in stages until a distinct haze is visible in the cooled product. Analysis of the polymer shows a residual styrene content in excess of 700 ppm. Special means are employed to remove the viscous polymer from the vacuum chamber. A gear pump with a very wide opening is employed. A sigma blade device with a smaller gear pump is also capable of removing the viscous polymer. Such a device is described by Moore et al in U.S. Pat. No. 4,954,303.

### Example 7

In a continuation of the run of example 6, at the reduced recirculation rate, the MA feed steam is replaced with a liquid stream of the methanol half ester of MA. When the polymerization reactor reaches steady state operation the S/MA copolymer (containing 25% of the half ester of MA) no longer has a detectable haze. Subsequently the recirculation rate is again slowed in several stages before a haze again developed. Analysis of the resulting polymer shows a residual styrene content below 300 ppm regardless of the degree of recirculation

Examples 6 and 7 illustrate several of the advantages of this invention. Most important again is the surprising reduction in residual monomer. It is also noted that increased level of MA results in an increase in stripping agent and thus lower volatile content. Again the equipment required to obtain even high content copolymers of styrene and MA is greatly simplified by the use of the half ester since the half ester is liquid at ambient conditions. Again, it is further seen that less agitation is required when polymerizing the half ester.

### Comparative Example 8

The process of example 4 of U.S. Pat. No. 3,919,354 is repeated to produce an impact (rubber modified) styrene copolymer with 19% MA. The Izod impact strength is 2.4 ft-lb/in and the elongation to break is 11%. Homogeneity is controlled in part by the recirculation rate in each of the stages. Recirculation in each of the three stages is decreased in 24 hour steps. A reduced recirculation point is reached where both the impact strength and the elongation to break is more than cut in half. Residual styrene monomer remains above 600 ppm for the whole series of runs.

### Example 9

In a continuation of the run of Example 8 at the reduced recirculation, the MA feed stream is replaced with a liquid, stream of the ethyl half ester of MA formed as in Example 2. When the polymerization reactor reaches steady state operation, at the reduced recirculation rates, the S/MA copolymer (containing 19% MA) regains the izod impact strength and elongation of the copolymer of example 4 of U.S. Pat. No. 3,919,354. The product, however now shows a more desirable residual styrene content below 400 ppm.

What is claimed is:

1. A process for producing a multi-polymers of an aromatic vinyl monomer of 8 to 12 carbon atoms with and an unsaturated dicarboxylic acid anhydride of 4 to 8 carbon atoms having low volatiles which comprises forming the half ester of a volatile alcohol having up to four carbon atoms with the anhydride of the unsaturated dicarboxylic acid, polymerizing the half ester with the aromatic vinyl monomer and subjecting the resulting polymer to devolatilization at temperatures above 180° C.

2. The process of claim 1 wherein the aromatic vinyl monomer is styrene and the anhydride is maleic anhydride.

3. The process of claim 2 wherein the maleic anhydride content is from 0.5 to 25% by weight of the polymerized anhydride and styrene.

4. The process of claim 1 wherein the alcohol is methanol or ethanol.

5. Claim 1 wherein the residual monomer level in the resulting copolymer is reduced by the stripping action of the molecularly dispersed volatile alcohol.

6. Claim 2 wherein the improved heat resistance imparted by the maleic anhydride is retained.

7. The press of claim 2 wherein the monomer mixture contains from 0.5 to 15% by weight of the total mixture of an unsaturated rubber.

8. A process for the devolatilization of vinyl aromatic monomer maleic anhydride copolymers comprising devolatilizing copolymer of the half ester of maleic anhydride and a volatile alcohol at elevated temperatures above 180° C. at reduced pressures.

9. The process of claim 8 where the vinyl aromatic polymer is styrene.

10. The process of claim 8 where the maleic anhydride content is 33 wt % of the copolymer or less.

11. The process of claim 8 where the maleic anhydride content is more than 2.0 wt % of the copolymer.

12. The process of claim 8 where the maleic anhydride content is more than 4.0 wt % of the copolymer.

13. The process of claim 8 wherein the half ester of the maleic anhydride and the volatile alcohol is formed in situ in the polymerization reactor.

14. The process of claim 8 where the alcohol is methanol, ethanol or isopropanol.

15. The process of claim 8 where the alcohol is contains from 1 to 4 carbon atoms

16. The process of claim 8 wherein a heater and a vacuum chamber is used in the devolatilization.

17. The process of claim 16 where the volatile organic content of the partial polymer entering the devolatilization vacuum chamber is between 6 and 55 wt %.

18. The process of claim 16 where the temperature of the polymer leaving the devolatilizer heater is above 200° C.

19. The process of claim 16 where the temperature of the polymer leaving the devolatilizer heater is between 200 and 260° C.

20. The process of claim 16 where the temperature of the polymer entering the vacuum chamber is between 200° C. and 260° C. and the pressure in the vacuum chamber is between 2 and 50 mm of mercury.
